(19) United States
(12) Patent Application Publication
(10) Pub. No.: US 2003/0188639 A1
(43) Pub. Date: Oct. 9, 2003

(54) Method for cooking rice

(76) Inventor: Toshiko Mori, New South Wales (AU)

Correspondence Address: FISH & RICHARDSON PC, 225 FRANKLIN ST, BOSTON, MA, 02110, US

(21) Appl. No.: 10/363,976

(22) PCT Filed: Sep. 7, 2001
(86) PCT No.: PCT/AU01/01130

(30) Foreign Application Priority Data
Sep. 7, 2000 (AU) PQ9972

(51) Int. Cl. A23L 3/00; A23L 3/26

(52) U.S. Cl. 99/451

(57) ABSTRACT

A method for cooking rice in a microwave oven including the steps of placing water and rice in a container in a predetermined ratio; substantially sealing the water and the rice in the container; placing the container, containing the water and the rice, into the microwave oven; setting the microwave oven to a low power level and operating the microwave oven at that level for a first period; setting the microwave oven to a high power level and operating the microwave oven at that level for a second period; and either setting the microwave oven to a low power level and operating the microwave oven at that level for a third period or letting the unopened container stand for said third period.

### FIELD OF THE INVENTION

This present invention relates to a method and apparatus for cooking rice in a microwave oven.

### BACKGROUND OF THE INVENTION

A traditional Japanese method for cooking short grain rice is described in “What's Cooking in Japan”, Kikkoman Corp., Tokyo, 1993. This traditional rice cooking method includes the following steps:

(i) Washing the rice and then allowing it to drain for approximately 30 minutes;

(ii) Soaking the rice in water for 30 minutes, where ratio of water/rice is in the range of 1.1 to 1.2, by volume;

(iii) Heating the rice over a medium heat until the water boils. Typically, this step takes around 10 minutes;

(iv) Reducing the heat and simmering the rice for around 10 minutes, ensuring that the water doesn't boil over;

(v) Cooking the rice over a low heat for a further period of 10 to 12 minutes;

(vi) Removing the rice from the heat and letting it sit covered for around 10 to 15 minutes;

(vii) Fluffing the rice with a damp wooden paddle; and

(viii) Draping a kitchen cloth over the rice and placing a lid on top of the cloth until serving.

The pre-cooking steps (i) and (ii) generally take around 60 minutes to complete and, although the rice will absorb some water during the washing and draining step (i), the rice will absorb most of its water during the soaking step (ii). The total cooking time involved in performing steps (iii) to (viii) is typically around 40 minutes. The total time required to perform steps (i) to (viii) is therefore around 1 hour and 40 minutes.

Microwave ovens provide a fast and efficient means for cooking many different food items, including rice. It is generally recommended to cook rice in a container with water on full power for a period which is proportional to the quantity of rice being cooked and the type and power level of the microwave oven being used.

A typical microwave oven cookbook such as “Microwave Cookbook, Janelle Bloom, Viling, Ringwood, Australia, 1996”, for example, recommends the use of a 2L casserole dish for 1 cup (250 mL) of rice and to cook the rice for 10 to 12 minutes without a cover at the maximum or high setting for an 850 Watt microwave oven. Rice cooked using this method typically does not absorb a sufficient amount of water to prevent the cooked rice from drying quickly. Rice cooked using this method typically dries up faster than rice cooked using the above-mentioned traditional Japanese cooking methods.

Although microwave ovens provide an efficient cooking means for most food types, microwave ovens have not been able to replace the need for the traditional pre-cooking steps required when cooking rice, particularly for short grain rice. As such, the traditional method must still be followed in order to produce good quality cooked rice, for the preparation of sushi rice, for example. If the pre-cooking steps are not followed, the quality of final product is compromised.

### SUMMARY OF THE INVENTION

In accordance with the present invention there is provided, a method for cooking rice in a microwave oven including the steps of:

(a) placing water and rice in a container in a predetermined ratio;

(b) substantially sealing the water and the rice in the container;

(c) placing the container, containing the water and the rice, into the microwave oven;

(d) setting the microwave oven to a low power level and operating the microwave oven at that level for a first period;

(e) setting the microwave oven to a high power level and operating the microwave oven at that level for a second period; and

(f) either setting the microwave oven to a low power level and operating the microwave oven at that level for a third period or letting the unopened container stand for said third period.

Preferably, the rice is short grain and the predetermined ratio is substantially 1.3 to 1.4 parts water, by volume, to 1 part rice, by volume.

Preferably, the rice is long grain and the predetermined ratio is substantially 1.2 parts water, by volume, to 1 part rice, by volume.

Preferably, egress of water vapour from the container is substantially precluded during cooking.

In accordance with the present invention there is also provided, a container for cooking water and short grain rice in a predetermined ratio, including a plurality of water level markings on an inner surface of the container, where each marking of said markings indicates the level to which the container should be filled with water for cooking a corresponding number of cups of short grain rice, the cup for measuring short grain rice being of a predetermined volume so that the water/rice ratio, by volume, is substantially in the range of 1.3 to 1.4.

In accordance with the present invention there is also provided, a container for cooking water and long grain rice in a predetermined ratio, including a plurality of water level markings on an inner surface of the container, where each marking of said markings indicates the level to which the container should be filled with water for cooking a corresponding number of cups of long grain rice, the cup for measuring long grain rice being of a predetermined volume so that the water/rice ratio, by volume, is substantially 1.2.

In accordance with the present invention there is also provided, a container for cooking rice and water, including a first set of water level markings on a portion of an inner surface of the container and a second set of water level markings on a further portion of the inner surface of the container, where each marking of said first set of markings corresponds to a number of cups of short grain rice to be cooked and indicates the level to which the container should be filled with water so that the water/rice ratio, by volume, is substantially in the range of 1.3 to 1.4 and where each marking of said second set of markings corresponds to a number of cups of long grain rice to be cooked and indicates the level to which the container should be filled with water to ensure that the water/rice ratio, by volume, is substantially 1.2, wherein the cup for measuring the cups of short grain rice and long grain rice is of a predetermined volume.

Preferably, the predetermined volume of the cup is 180 mL.

Preferably, egress of water vapour from the container is substantially precluded when water is heated in the container.

In accordance with the present invention there is also provided, a microwave oven being programmable to operate at a low power level for a first predetermined period; operate at a high power level for a second predetermined period; and operate at a low power level for a third predetermined period.

Preferably, a microwave oven as claimed in claim 22, wherein the microwave oven is a 1,100 Watt phase control type microwave oven and for 2 cups of either short grain or long grain rice, the first predetermined period is substantially 10 minutes; the second predetermined period is substantially 10 minutes and the third predetermined period is substantially 5 minutes.

Preferably, the microwave oven is a 600 Watt duty cycle type microwave oven and for 2 cups of either short grain or long grain rice, the first predetermined period is substantially 15 minutes; the second predetermined period is substantially 10 minutes and the third predetermined period is substantially 5 minutes.

In accordance with the present invention there is also provided a method for cooking rice using a microwave oven of the above described type, including the steps of:

(a) placing water and rice in a container in a predetermined ratio;

(b) substantially sealing the water and the rice in the container;

(c) placing the container, containing the water and the rice, into the microwave oven;

(d) setting the microwave oven to the low power level and operating the microwave oven at that level for the first predetermined period;

(e) setting the microwave oven to the high power level and operating the microwave oven at that level for the second predetermined period; and

(f) either setting the microwave oven to the low power level and operating the microwave oven at that level for the third predetermined period or letting the unopened container stand for said third period.

Preferably, said microwave oven has a control means for executing the steps in sequence.

In accordance with the present invention there is also provided, a container for cooking water and short grain rice in a predetermined ratio, including a plurality of level markings, wherein each marking of said markings indicates the level to which the container is filled with water for cooking a corresponding number of cups of short grain rice, the cup for measuring short grain rice being of a predetermined volume so that the water/rice ratio, by volume, is substantially in the range of 1.3 to 1.4.

Preferably, the cup for measuring short grain rice is substantially 180 mL.

In accordance with the present invention there is also provided, a container for cooking water and long grain rice in a predetermined ratio, including a plurality of level markings, wherein each marking of said markings indicates the level to which the container is filled with water for cooking a corresponding number of cups of long grain rice, the cup for measuring long grain rice being of a predetermined volume so that the water/rice ratio, by volume, is substantially 1.2.

Preferably, the cup for measuring long grain rice is substantially 195 mL.

In accordance with the present invention there is also provided, a container for cooking rice and water, including a first set of level markings and a second set of level markings, wherein each marking of said first set of markings corresponds to a number of cups of short grain rice to be cooked and indicates the level to which the container should be filled with water so that the water/rice ratio, by volume, is substantially in the range of 1.3 to 1.4, and wherein each marking of said second set of markings corresponds to a number of cups of long grain rice to be cooked and indicates the level to which the container should be filled with water to ensure that the water/rice ratio, by volume, is substantially 1.2, the cup for measuring both the short grain rice and the long grain rice being of a predetermined volume.

Preferably, the predetermined volume of the cup is 180 mL.

Preferably, egress of water vapour from the container is substantially precluded when water is heated in the container.

Preferably, said microwave oven has a control means for executing the steps in sequence.

### BRIEF DESCRIPTION OF THE DRAWINGS

Preferred embodiments of the invention will now be described, by way of non-limiting example only, with reference to the accompanying drawings in which:

FIG. 1 illustrates a front portion of a microwave oven in accordance with the invention;

FIG. 2 is a schematic diagram of the microwave oven of FIG. 1;

FIG. 3 is graph representing cooking times for various types of microwave ovens in accordance with the invention; and

FIG. 4 is a perspective view of a container in accordance with the invention.

### DETAILED DESCRIPTION OF PREFERRED EMBODIMENTS OF THE INVENTION

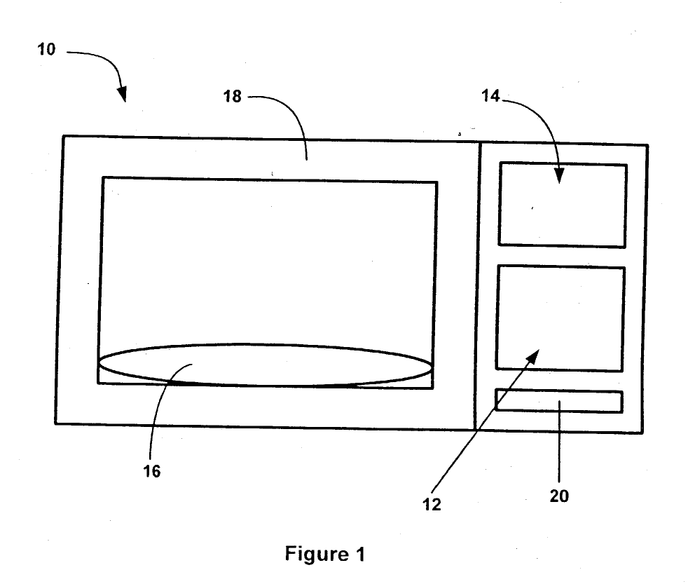

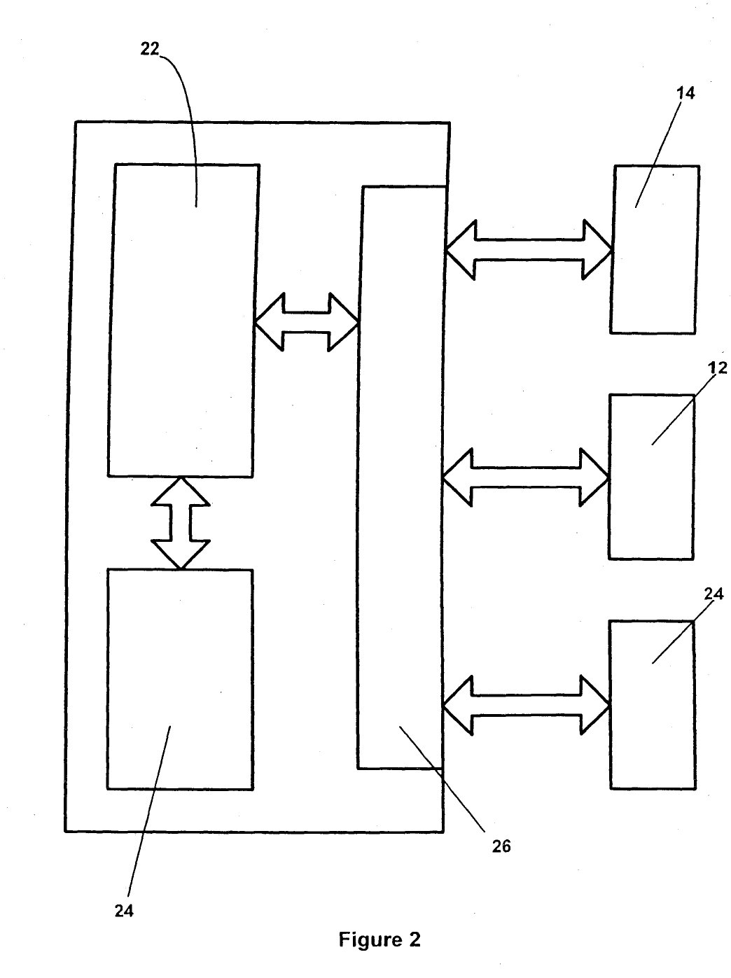

A microwave oven 10 shown in FIG. 1 includes a control panel 12, a display 14, a rotatable plate 16, a door 18 and a door opener 20. The microwave oven 10 is controlled by a microprocessing unit 22, shown in FIG. 2, which uses memory 22 to store data. The microprocessing unit 22 interfaces with the display 14, the control panel 12 and a magnetron 24 via the interface port 26.

A user of the microwave oven 10 interacts with the microwave oven 10 by pressing the keypad buttons (not shown) on the control panel 12. The microprocessing unit 22 receives the instructions entered by the user and displays the instructions on the display 14. The microprocessing unit 22 also stores these instructions in the memory 24. When the user has finished entering their instructions, the user presses a “START” button (not shown) on the keypad and the microprocessing unit 22 begins executing the user's instructions as stored in the memory 24.

The microprocessing unit 22 operates by switching the magnetron 14 on and off in accordance with the user's instructions. The magnetron 14 is the component used in microwave ovens to generate the microwaves.

The microprocessing unit 22 may use a phase control method of controlling the magnetron. In this method the nominal full power of the microwave oven 10 is reduced and the reduced power is delivered continuously over the cooking time nominated by the user. Accordingly, a low power level may be an average of substantially one tenth of the full power of the magnetron, substantially sustained over the entire nominated cooking period.

Alternatively, the microprocessing unit 22 may use a duty cycle technique to control the magnetron 14. In this technique, the cooking time is divided into a number of duty cycles and microprocessing unit 22 switches the microwave oven's magnetron on and off in accordance with a predetermined portion of the duty cycle. In a microwave oven 10 of this kind, the power generated during the “on” parts of the duty cycle is essentially the full power of the microwave oven. The predetermined portion of the duty cycle corresponds to the power level selected by the user. For example, a 600 Watt microwave oven 10 may have a 32 sec duty cycle. If a user selects a low power level, the magnetron 14 delivers power at full strength (600 Watt) for a period of 3 sec every 32 seconds. Conversely, for the same 600 Watt microwave oven 10, if a user selects a high power level, the magnetron delivers power at full strength (600 Watt) for a period of full 32 seconds.

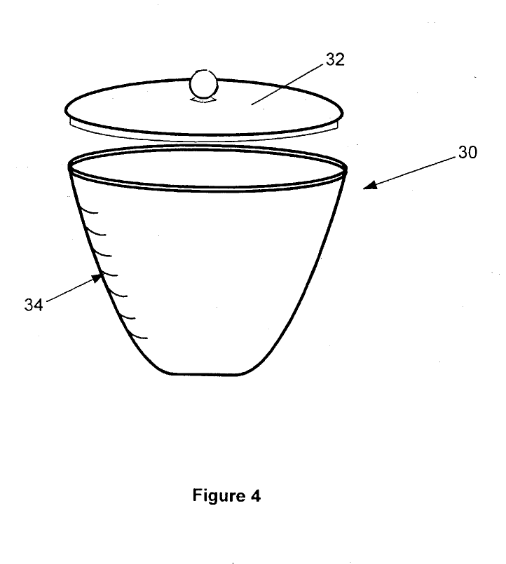

The invention is more fully explained by way of non-limiting examples only with reference to the container 30, as shown in FIG. 4.

### EXAMPLE 1

Where the microwave oven 10 is a 600 Watt duty cycle type the following steps are performed in order to cook short grain rice:

(i) Measure 2 cups (the cup measuring 180 mL by volume) of the rice and wash and drain the rice;

(ii) Pour the rice into a microwave proof container 30 and add 468 mL of water;

(iii) Seal the container 30 with the lid 32, so that steam will generally be prevented from escaping the container during the cooking processes;

(iv) Cook the rice on a low power level for 15 minutes;

(v) Cook the rice on a high power level 10 minutes; and

(vi) Cook the rice on a low power level for 5 minutes.

### EXAMPLE 2

Where the microwave oven 10 is a 1,100 Watt phase control type the following steps are performed in order to cook short grain rice:

(i) Measure 2 cups (the cup measuring 180 mL by volume) of the rice and wash and drain the rice;

(ii) Pour the rice into a microwave proof container 30 and add 468 mL of water;

(iii) Seal the container 30 with the lid 32, so that steam will generally be prevented from escaping the container during the cooking processes;

(iv) Cook the rice on a low power level for 10 minutes;

(v) Cook the rice on a high power level 10 minutes; and

(vi) Cook the rice on a low power level for 5 minutes.

### EXAMPLE 3

Where the microwave oven 10 is a 1,100 Watt phase control type the following steps are performed in order to cook long grain rice:

(i) Measure 2 cups (the cup measuring 180 mL by volume) of the rice and wash and drain the rice;

(ii) Pour the rice into a microwave proof container 30 and add 432 mL of water;

(iii) Seal the container 30 with the lid 32, so that steam will generally be prevented from escaping the container during the cooking processes;

(iv) Cook the rice on a low power level for 10 minutes;

(v) Cook the rice on a high power level 10 minutes; and

(vi) Cook the rice on a low power level for 5 minutes.

The initial cooking step (iv) in each one of Examples 1 to 3 simulates the above-mentioned traditional Japanese precooking step (ii) of soaking the rice in water for a period of 30 minutes. This initial cooking step (iv) gently warms the water in the container 30 and thereby promotes the absorption of water by the rice grains inside the container.

Preventing water vapour escaping from the container 30 maintains a constant amount of water in the container. By maintaining a constant amount of water in the container 30, water to rice ratios can be accurately predicted and thereby consistently produce quality rice for sushi making, for example. In the event that water was lost during the cooking process, the cooking times may be unpredictable and as a result the quality of the sushi rice produced would be compromised.

Generally, for a domestic phase control type microwave oven of 1,100 Watts the above-mentioned cooking step (v) involves 10 minutes of heating for 2 cups of rice; 13 minutes for heating 3 cups of rice and 15 minutes for heating 4 cups of rice.

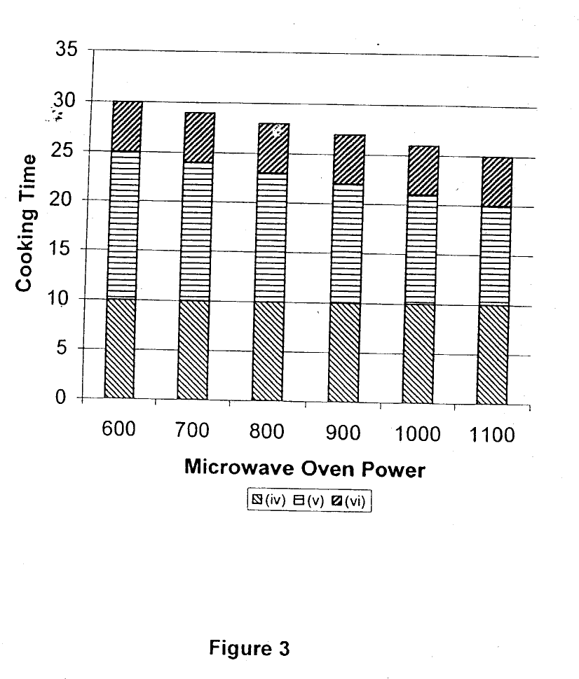

Examples of cooking times for 2 cups of rice for different microwave oven 10 operating powers are shown in FIG. 3. The time required for the initial cooking step (iv) is ten minutes and this time does not tend to be proportional to the power of the microwave oven being used. The time required to complete the second cooking step (v) decreases as the microwave oven's 10 operating power increases. The time required for the final cooking step (vi) is 5 minutes and is independent to the power of the microwave oven 10.

In one embodiment of the invention, the final cooking step (vi) may be replaced by the step of letting the rice stand without additional heating for a period of 5 minutes.

As shown in FIG. 3, the heating times for the second cooking step (v) vary. The variance is due to different nominal power levels of the microwave ovens 10 and different microwave oven 10 designs. As a general guide to determining the required time for the second cooking step (v), a reduction of 1 minute is required for each 100 Watts increase of microwave oven power above 600 Watts. Heating efficiency in microwave ovens 10 is dependant on, for example, the number of wave guides, the microwave emission method, the rotation of rotatable plate 16, the container's position on the rotatable plate 16 and so forth. Preferably, the container 30 is positioned on the rotatable plate 16 so that it goes through the most effective microwave field.

In one embodiment of the invention, the container 30 is a known device marketed under the trade mark “Rice Cooker”, manufactured by Star Industrial Co. Ltd. This device is essentially a container designed to be useful in cooking rice in a microwave oven 10 and is adapted to substantially prevent steam escaping from the container 30. The water to rice ratio can therefore be more accurately predicted and maintained and higher quality rice is produced when used in conjunction with the above-mentioned rice cooking methods.

In a preferred embodiment of the invention a container 30 is adapted to substantially prevent steam escaping and has two sets of internal markings. The first set of markings 34 correspond to the number of cups (the cup measuring 180 mL by volume) of short grain rice being cooked and indicate the level to which the container should be filled with water, after the rice has been added to the container, to ensure that the water/rice ratio, by volume, is substantially in the range of 1.3 to 1.4. The second set of markings (not shown) correspond to the number of cups (the cup measuring 180 mL by volume) of long grain rice being cooked and indicate the level to which the container should be filled with water, after the rice has been added, to ensure that the water/rice ratio, by volume, is substantially 1.2. Both sets of markings are based on the use of a common cup size of 180 mL.

In this embodiment of the invention the following steps are executed for cooking 2 cups (the cup measuring 180 mL by volume) of short grain rice in a 1,100 Watt continuous power microwave oven:

(i) Measure two cups of short grain rice;

(ii) Wash and drain the short grain rice;

(iii) Pour the rice into the above-mentioned container 30 and then add water until the water is level with the mark 34 on the inside of the container that corresponds to 2 cups short grain rice and seal the container 30 with the lid 32, so that steam will generally be prevented from escaping the container 30 during the cooking processes;

(iv) Heat the rice on a low power setting for 10 minutes;

(v) Heat the rice on a high power setting for 10 minutes; and

(vi) Either heat the rice on a lower power setting for 5 minutes or let the rice stand without additional heating for 5 minutes.

In this embodiment of the invention the following steps are executed for cooking 2 cups, (the cup measuring 180 mL by volume) of long grain rice in a 1,100 Watt continuous power microwave oven:

(i) Measure two cups of long grain rice;

(ii) Wash and drain the long grain rice;

(iii) Pour the rice into the above-mentioned container 30 and then fill the container with water until the water is level with the mark (not shown) on the inside of the container that corresponds to 2 cups long grain rice and seal the container 30 with the lid 32, so that steam will generally be prevented from escaping the container 30 during the cooking processes;

(iv) Heat the rice on a low power setting for 10 minutes;

(v) Heat the rice on a high power setting for 10 minutes; and

(vi) Either heat the rice on a lower power setting for 5 minutes or let the rice stand without additional heating for 5 minutes.

The amount of time required for cooking both the short and the long grain rice in step (vii) is dependent on the power output and type of microwave oven used. Cooking times for steps (iv), (v) and (vi) for both long and short grain rice, for various microwave oven power ratings, are provided in FIG. 3.

In a preferred embodiment of the invention, the microwave oven 10 has a control means for executing the above-mentioned cooking steps (iv) to (vi) in sequence as a single heating program.

In a further embodiment of the invention a container 30, adapted to substantially prevent steam escaping, has one set of internal markings 34 corresponding to the number of cups of rice being cooked that indicate the level to which the container 30 should be filled with water, after the rice has been added to the container, to ensure that the appropriate water/rice ratio, by volume, is substantially obtained. In this embodiment of the invention, precise measuring cups are provided, one for each type of grain of rice to be cooked in the microwave. The cups maintain the above-mentioned water/rice ratios, by volume, of 1.3 for short grain rice and 1.2 for long grain rice.

In preferred embodiments of the invention the microwave oven 10 is a domestic microwave oven.

The described arrangement has been an advanced merely by way of explanation and many modifications may be made thereto without departing from the spirit and scope of the invention which includes every novel feature and combination of novel features herein disclosed.

1. A method for cooking rice in a microwave oven including the steps of:
(a) placing water and rice in a container in a predetermined ratio;
(b) substantially sealing the water and the rice in the container;
(c) placing the container, containing the water and the rice, into the microwave oven;
(d) setting the microwave oven to a low power level and operating the microwave oven at that level for a first period;
(e) setting the microwave oven to a high power level and operating tile microwave oven at that level for a second period; and
(f) either setting the microwave oven to a low power level and operating the microwave oven at that level for a third period or letting the unopened container stand for said third period.

2. (New) A method as claimed in claim 1, wherein step (f) is setting tile microwave oven to the low power level and operating the microwave oven at that level for the third period.

3. (New) A method as claimed in claim 2, wherein the third period is less than or equal to 5 minutes.

4. (New) A method as claimed in claim 1, wherein step (f) is letting the unopened container stand for the third period.

5. (New) A method as claimed in claim 4, wherein the third period is substantially 5 minutes

6. (Amended) A method as claimed in any one of claims 1 to 5, including the step of washing the rice before placing the water and the rice in the container.

7. (Amended) A method claimed in any one of claims 1 to 6, wherein the rice is short grain and the predetermined ratio is substantially 1.3 to 1.4 parts water, by volume, to 1 part rice, by volume.

8. (Amended) A method claimed in any one of claims 1 to 6, wherein the rice is long grain and the predetermined ratio is substantially 1.2 parts water, by volume, to 1 part rice, by volume.

9. (Amended) A method claimed in any one claim of the previous claims, wherein the microwave oven is a 1,100 Watt phase controlled type microwave oven and, for 2 cups (the cup measuring 180 mL by volume) of rice, the first period is substantially 10 minutes, the second period is substantially 10 minutes and the third period is substantially 5 minutes.

10. (Amended) A method claimed in any one claim of claims 1 to 8, wherein the microwave oven is a 1,100 Watt phase controlled type microwave oven and, for 3 cups (the cup measuring 180 mL by volume) of rice, the first period is substantially 10 minutes, the second period is substantially 13 minutes and the third period is substantially 5 minutes.

11. (Amended) A method claimed in any one claim of claims 1 to 8, wherein the microwave oven is a 1,100 Watt phase controlled type microwave oven and, for 4 cups (the cup measuring 180 mL by volume) of rice, the first period is substantially 10 minutes, the second period is substantially 15 minutes and the third period is substantially 5 minutes.

12. (Amended) A method claimed in any one claim of claims 1 to 8, wherein the microwave oven is a 600 Watt duty cycle type microwave oven and, for 2 cups (the cup measuring 180 mL by volume) of rice, the first period is substantially 15 minutes, the second period is substantially 10 minutes and the third period is substantially 5 minutes.

13. A method as claimed in any one of the preceding claims, wherein egress of water vapour from the container is substantially precluded during cooking.

14. A container for cooking water and short grain rice in a predetermined ratio, including a plurality of water level markings on an inner surface of the container, where each marking of said markings indicates the level to which the container should be filled with water for cooking a corresponding number of cups of short grain rice, the cup for measuring short grain rice being of a predetermined volume so that the water/rice ratio, by volume, is substantially in the range of 1.3 to 1.4.

15. (Amended) A container as claimed in claim 14, where in the cup is substantially 180 mL.

16. (Amended) A container for cooking water and long grain rice in a predetermined ratio, including a plurality of water level markings on an inner surface of the container, where each marking of said markings indicates the level to which the container should be filled with water for cooking a corresponding number of cups of long grain rice, the cup for measuring long grain rice being of a predetermined volume so that the water/rice ratio, by volume, is substantially 1.2.

17. (Amended) The container claimed in claim 16, wherein the cup is substantially 195 mL.

18. (Amended) A container for cooking rice and water, including a first set of water level markings on a portion of an inner surface of the container and a second set of water level markings on a further portion of the inner surface of the container, wherein each marking of said first set of markings corresponds to a number of cups of short grain rice to be cooked and indicates the level to which the container should be filled with water so that the water/rice ratio, by volume, is substantially in the range of 1.3 to 1.4 and wherein each marking of said second set of markings corresponds to a number of cups of long grain rice 16 to be cooked and indicates the level to which the container should be filled with water to ensure that the water/rice ratio, by volume, is substantially 1.2, wherein the cup for measuring the cups of short grain rice and long grain rice is of a predetermined volume.

19. A container as claimed in claim 18, wherein the predetermined volume of the cup is 180 mL.

20. A container claimed in any one of claims 14 to 19, where egress of water vapour from the container is substantially precluded when water is heated in the container.

21. A container claimed in any one of claims 14 to 20, wherein the markings indicate the correct amount of water to be added to the container once the rice has been added to the container.

22. A microwave oven being programmable to operate at a low power level for a first predetermined period; operate at a high power level for a second predetermined period; and operate at a low power level for a third predetermined period.

23. A microwave oven as claimed in claim 22, wherein the microwave oven is a 1,100 Watt phase control type microwave oven and for 2 cups of either short grain or long grain rice, the first predetermined period is substantially 10 minutes; the second predetermined period is substantially 10 minutes and the third predetermined period is substantially 5 minutes.

24. (Amended) A microwave oven as claimed in claim 22, wherein the microwave oven is a 600 Watt duty cycle type microwave oven and for 2 cups of either short grain or long grain rice, the first predetermined period is substantially 15 minutes; the second predetermined period is substantially 10 minutes and the third predetermined period is substantially 5 minutes.

25. (Amended) A method for cooking rice using the microwave oven claimed in claim 22 including the steps of:
(a) placing water and rice in a container in a predetermined ratio;
(b) substantially sealing the water and the rice in the container,
(c) placing the container, containing the water and We rice, into the microwave oven;
(d) setting the microwave oven to the low power level and operating the microwave oven at that level for the first predetermined period;
(e) setting the microwave oven to the high power level and operating the microwave oven at that level for the second predetermined period; and
(f) either setting the microwave oven to the low power level and operating the microwave oven at that level for the third predetermined period or letting the unopened container stand for said third period.

26. (New) A method as claimed in claim 25, wherein step (i) is setting the microwave oven to the low power level and operating the microwave oven at that level for the third predetermined period.

27. (New) A method as claimed in claim 26, wherein the third predetermined period is less than or equal to 5 minutes.

28. (New) A method as claimed in claim 25, wherein step (i) is letting the unopened container stand for the third predetermined period.

29. A method as claimed in claim 28, wherein the third predetermined period is substantially 5 minutes.

30. A method as claimed in any one of claims 25 to 29, wherein said microwave oven has a control means for executing the steps in sequence.

31. A container for cooking water and short grain rice in a predetermined ratio, including a plurality of level markings, wherein each marking of said markings indicates the level to which the container is filled with water for cooking a corresponding number of cups of short grain rice, the cup for measuring short grain rice being of a predetermined volume so that the water/rice ratio, by volume, is substantially in the range of 1.3 to 1.4.

32. The container claimed in claim 22, wherein the cup for measuring short grain rice is substantially 180 mL.

33. A container for cooking water and long grain rice in a predetermined ratio, including a plurality of level markings, wherein each marking of said markings indicates the level to which the container is filled with water for cooking a corresponding number of cups of long grain rice, the cup for measuring long grain rice being of a predetermined volume so that the water/rice ratio, by volume, is substantially 1.2.

34. The container claimed in claim 24, wherein the cup for measuring long grain rice is substantially 195 mL.

35. (Amended) A container for cooking rice and water, including a first set of level markings and a second set of level markings, wherein each marking of said first set of markings corresponds to a number of cups of short grain rice to be cooked and indicates the level to which the container should be filled with water so that the water/rice ratio, by volume, is substantially in the range of 1.3 to 1.4, and wherein each marking of said second set of markings corresponds to a number of cups of long grain rice to be cooked and indicates the level to which the container should be filled with water to ensure that the water/rice ratio, by volume, is substantially 1.2, the cup for measuring both the short grain rice and the long grain rice being of a predetermined volume.

36. A container as claimed in claim 26, wherein the predetermined volume of the cup is 180 mL.

37. A container claimed any one of claims 22 to 27, wherein egress of water vapour from the container is substantially precluded when water is heated in the container.

38. A container claimed in any one of claims 22 to 28, wherein the markings indicate the correct amount of water to be added to the container once the rice has been added to the container.
